(19) United States
(12) Patent Application Publication
(10) Pub. No.: US 2019/0297869 A1
(43) Pub. Date: Oct. 3, 2019

(54) WEED-DAMAGING DEVICE

(71) Applicant: Robert Bosch GmbH, Stuttgart (DE)

(72) Inventors: Andreas Michaels, Magstadt (DE); Steffen Petereit, Freiberg am Neckar (DE)

(21) Appl. No.: 16/325,668

(22) PCT Filed: Jul. 28, 2017
(86) PCT No.: PCT/EP2017/069188

§ 371 Date: Apr. 10, 2019

(30) Foreign Application Priority Data
Aug. 19, 2016 (DE) 10 2016 215 566.0

(51) Int. Cl. A01M 21/02; A01M 21/04

(52) U.S. Cl. CPC A01M 21/02; A01B 39/18; A01M 21/043

(57) ABSTRACT

A device for damaging weeds, having a movably arranged plunger, which has a plunger end for applying pressure to a weed to damage the weed mechanically, and to an active-substance dispensing unit, which is configured to dispense an active substance onto the plunger end of the plunger to damage chemically the mechanically damaged weed.

### FIELD OF THE INVENTION

The present invention relates to a device, a system and a method for damaging weeds.

### BACKGROUND INFORMATION

To reduce the use of herbicides in cultivation, weeds can be removed by a purely mechanical arrangement, e.g. by punching weeds mechanically back into the ground. In most cases, this is sufficient to kill off the growth that is pushed back into the ground. However, particularly robust weeds can survive this and grow back to the surface of the soil. In many cases, the time this takes is sufficient to give the crop plant a lead in terms of growth. In slow-growing crops, however, this may not be sufficient: the weeds that reappear also have to be combated repeatedly in subsequent weeding sessions. This increases the number of punching operations, slowing down the weeding process.

Patent document DE 10 2013 222 776 A1 discusses a device in which pressure is applied to the weeds by a movably mounted plunger. In this process, the weeds are pressed into the ground in a targeted manner using the plunger and are thereby mechanically damaged, while the crop plants growing at a short distance therefrom remain undamaged.

Patent document CA 2410843 A1 discusses a device for removing plant roots in which the device is positioned above the plant by way of pins and wherein an operating element can be used to plunge a point situated between the pins into the center of the plant. The operating element connected to the point is returned by a return spring.

Patent document DE 195 02 010 A1 discusses a method for removing wild plant growth on areas such as paths, squares and courtyard paving. In this case, a working element of a brush-type configuration is pressed against the ground covering, the component performing a movement of a vehicle to which the component is attached at least approximately transverse to the direction of travel.

### SUMMARY OF THE INVENTION

Given this situation, the approach presented here is to provide a device, a system and a method for damaging weeds in accordance with the descriptions herein.

The approach presented here provides a device for damaging weeds, having a movably arranged plunger, which has a plunger end for applying pressure to a weed in order to mechanically damage the weed, and having an active-substance dispensing unit, which is configured to dispense an active substance onto the plunger end of the plunger in order to additionally chemically damage the mechanically pre-damaged weed.

The approach presented here furthermore provides a system for damaging weeds having a device described above, wherein the system is configured as a vehicle, in particular as an autonomous vehicle, or as a handheld device.

The approach presented here furthermore provides a method for damaging weeds, which is carried out, in particular, using a device described above or a system described above, having the following steps:
supplying a movably arranged plunger having a plunger end;
dispensing an active substance onto the plunger end of the plunger using an active-substance dispensing unit;
applying pressure to the weed using the plunger end of the plunger in order to mechanically damage the weed; and
dispensing the active substance from the plunger end of the plunger onto the weed by contact transfer in order additionally to damage chemically the mechanically pre-damaged weed.

The plunger may be of an elongate configuration. The plunger may furthermore be of a cylindrical configuration. The plunger may have a constant or varying cross section. The plunger may be of a circular cylindrical configuration. The plunger may be arranged or mounted in such a way that it may be moved in a translational manner. The translational movement may be a purely linear movement. However, the translational movement may also have a superposed rotary component in addition to the linear movement. Accordingly, the plunger is also able to perform a translational movement resulting from a rotary movement, e.g. a screw-type movement, and may thus be mounted for translational movement.

Application of pressure may be understood as a punching operation or a dabbing operation, for example. However, the application of pressure may also include a cutting operation or may be a cutting operation.

In particular, the active-substance dispensing unit is configured to dispense a defined or predefined quantity of active substance onto the plunger end of the plunger. That is to say, in other words, that the active-substance dispensing unit is configured or set up to dispense a particular quantity of active substance onto the plunger end of the plunger.

The active substance may be gaseous, liquid, in powder form, in dust form or in solid form. The active substance may be a weed killer or a herbicide.

Dispensing may be understood as conveying, spraying, squirting, applying, discharging and/or transferring active substance in any way known to a person skilled in the art onto the plunger end of the plunger.

The vehicle may be a tractor attachment or a self-driving work vehicle. The system may be guided automatically or autonomously. However, the system may also be configured to be guided by hand. In this case, the system may have a stick-type support on which the device is arranged or into which the device is integrated.

The device according to the invention and the system according to the invention allow for a combined operation comprising mechanical and chemical damage to weeds to be performed simultaneously or directly in succession. According to the present invention, an active substance is first dispensed onto the plunger end of the plunger by an active-substance dispensing unit. The plunger is then extended and pressure is applied to or a punching action performed on the weed by the plunger end of the plunger, thereby mechanically damaging the weed. Smashing the plant bursts the capillaries, and the plant cells break open. Since the previously dispensed active substance is arranged on the plunger end, the plant mass comes into direct contact with the active substance simultaneously with or directly after the mechanical pre-damaging process, and therefore the active substance is able to act directly on the plant body or on the biological material and additionally damages the weed chemically. Since, depending on the type of plant, plant fluids also emerge as the weed is crushed, solid active substances or solid herbicides can also be used in these cases, these releasing a sufficient quantity of active substance when wetted by the plant fluids.

Consequently, effective damaging or killing of weeds may be advantageously performed using the device according to the invention, the system according to the invention and the method according to the invention while significantly minimizing the active substance quantity required. Moreover, contact transfer of the active substance to the weed makes it possible to prevent spraying or dripping losses and active substance contamination of other areas and plants. Another advantage is that it is possible to avoid pressing or punching the weed deep into the ground. In sandy ridge culture, e.g. in the cultivation of carrots, the ridges can be damaged by the action of great forces. In this case, the punching operation is performed at reduced pressure, ensuring that the weed is pressed below the surface of the soil only by a short distance and that, at the same time, it is dabbed with the active substance.

It is furthermore advantageous if the active-substance dispensing unit is configured to convey and/or guide and/or spray and/or squirt the active substance onto the plunger end of the plunger and/or to transfer it to said plunger end by brushing contact. It is advantageous here if the active-substance dispensing unit has at least one feed line having an opening, wherein the opening is connected fluidically to the plunger end and/or is arranged in the region of the plunger end in a retracted position of the plunger. Here, the retracted position may be the position in which the plunger is arranged before extension or activation. It is advantageous here if the feed line can be connected and/or is connected fluidically to an active-substance chamber. This measure is a simple way of dispensing the active substance onto the plunger end of the plunger before the application of pressure or the punching operation.

It is furthermore advantageous if the feed line is arranged at least partially within the plunger and the opening of the feed line is connected fluidically to the plunger end of the plunger. This makes it possible for the active-substance dispensing unit to be integrated at least partially into the plunger, thus allowing for the active substance to be conveyed or guided to the plunger end within the plunger. This allows for a very compact construction of the device. In this case, the active substance may furthermore also be in solid form.

It is furthermore advantageous if the feed line is arranged at least partially outside the plunger and the opening of the feed line is arranged in the region of the plunger end of the plunger. In this case, the opening of the feed line may be arranged in a region between the plunger end and the ground. By virtue of this measure, the active substance may be, for example, sprayed or squirted onto the plunger end from outside the plunger.

It is furthermore advantageous if the opening of the feed line is arranged in such a way in the region of the plunger end of the plunger that, when the plunger moves from the retracted position into a pressure application position, brushing contact occurs between the plunger end and the opening of the feed line. It is particularly advantageous in this case if a multiplicity of feed lines having openings is provided, the openings being arranged, in particular being arranged in a ring shape, around the plunger end of the plunger.

In this case, the feed line or feed lines may form a “wiper”, which is wetted with the active substance. The feed lines may furthermore form a “wiper ring”, which is wetted with the active substance. In the retracted position or retracted state, the plunger end is arranged ahead of the wiper in the direction of the extending movement. During the extending movement of the plunger, i.e. the movement of the plunger from the retracted position into the pressure application position, the plunger end brushes the wiper and takes along or picks up a very small quantity of active substance. By virtue of this measure, the active substance may be dispensed or transferred onto the plunger end in a very simple manner from outside the plunger by brushing contact.

It is furthermore advantageous if the active-substance dispensing unit has an activation unit which is configured to bring about dispensing of the active substance onto the plunger end of the plunger as a function of a travel distance or a position of the plunger and/or a pressure force acting on the plunger end of the plunger. In particular, it is advantageous if the activation unit has a valve, in particular a return valve, and is furthermore configured to open the valve at or after a predefined pressure force on the valve in order to bring about dispensing of the active substance onto the plunger end. It is furthermore advantageous if the activation unit has a pressure sensor, which is arranged on the plunger end of the plunger, it being possible to open the valve via a signal of the pressure sensor, and/or has a pump, in particular a piston pump or diaphragm pump, which is arranged and configured to dispense or spray a predefined quantity of active substance onto the plunger end at or after a predefined travel or a predefined position of the plunger. The predefined position of the plunger may be a predefined position of the plunger relative to the device or to the active-substance dispensing unit.

However, the predefined position of the plunger may also be a predefined position of the plunger relative to the weed. The predefined position of the plunger may be the retracted position. The predefined travel of the plunger may be a predefined travel of the plunger relative to the device or to the active-substance dispensing unit. The predefined position of the plunger may be a predefined travel of the plunger relative to the weed. The predefined travel of the plunger may be the pressure application position. The activation unit may be configured as the “wiper” or “wiper ring” described above and may bring about dispensing of the active substance onto the plunger end on contact between the plunger and the feed line. In this case, it is also advantageous, in particular, if the plunger end is connected and/or may be connected fluidically to an active-substance chamber by the feed line, the fluidic connection being able to be interrupted as a function of a travel of the plunger. That is to say, in other words, that the feed line which connects the plunger end fluidically to the active-substance chamber is of an interruptible configuration and, as a result, the supply of active substance from the active-substance chamber to the plunger end may likewise be interrupted. In this case, the feed line may be configured in such a way that it is separated from the active-substance chamber at least in the retracted position and in the pressure application position and is connected and/or may be connected at least partially to the active-substance chamber between these two positions. However, the feed line may also be configured in such a way that it is connected and/or may be connected to the active-substance chamber in the retracted position and is separated from the active-substance chamber in the pressure application position and in the positions therebetween. By this measure, the active-substance dispensing operation, i.e. the application or spraying operation, may be activated or started in a simple manner. Moreover, a predefined active substance quantity may be picked up before or during the extending movement of the plunger and dispensed directly or subsequently onto the plunger end.

It is furthermore advantageous if the plunger has a depression to receive the active substance at the plunger end. It is particularly advantageous here if the depression is conical or frustoconical. That is to say, in other words, that the plunger is recessed at the plunger end. Since this depression or pocket containing the active substance is placed over the weed during the punching operation, a small quantity of active substance may be both picked up more effectively by the plunger end and dispensed more effectively onto the weed as a result.

It is furthermore advantageous if the plunger is of a sharp-edged configuration at the plunger end, in particular being configured as an annular cutting edge. During the punching or stamping operation, the plant body of the weed is pressed or rammed onto/into the ground by the plunger end of the plunger and is thereby greatly compressed. Accordingly, the punching operation on or damaging of the weed may be performed even more effectively by a sharp-edged plunger end configured, in particular, as an annular cutting edge, and it is also possible for the leaves of the weed which protrude from the punching zone to be cut off at the same time, for example.

In the following text the present invention will be explained in greater detail by way of example with reference to the attached drawings.

In the following description of exemplary embodiments of the present invention, identical or similar reference symbols are used for the similarly acting elements illustrated in the various figures, while repeated description of the elements is avoided.

### BRIEF DESCRIPTION OF THE DRAWINGS

FIGS. 1a and 1b show a schematic illustration of a first embodiment of a weed damaging device according to the invention having a wiper ring.

FIGS. 2a, 2b and 2c show a schematic illustration of a second embodiment according to the invention of the weed damaging device with a feed line extending within the plunger.

FIGS. 3a, 3b, 3c and 3d show a schematic illustration of a third embodiment according to the invention of the weed damaging device having a feed line extending within the plunger.

FIGS. 4a, 4b and 4c show a schematic illustration of a second embodiment according to the invention of the weed damaging device having a feed line extending outside of the plunger.

FIG. 5 shows a schematic illustration of a plunger end with an active substance pin.

FIG. 6 shows a flow chart of a method for damaging weeds.

### DETAILED DESCRIPTION

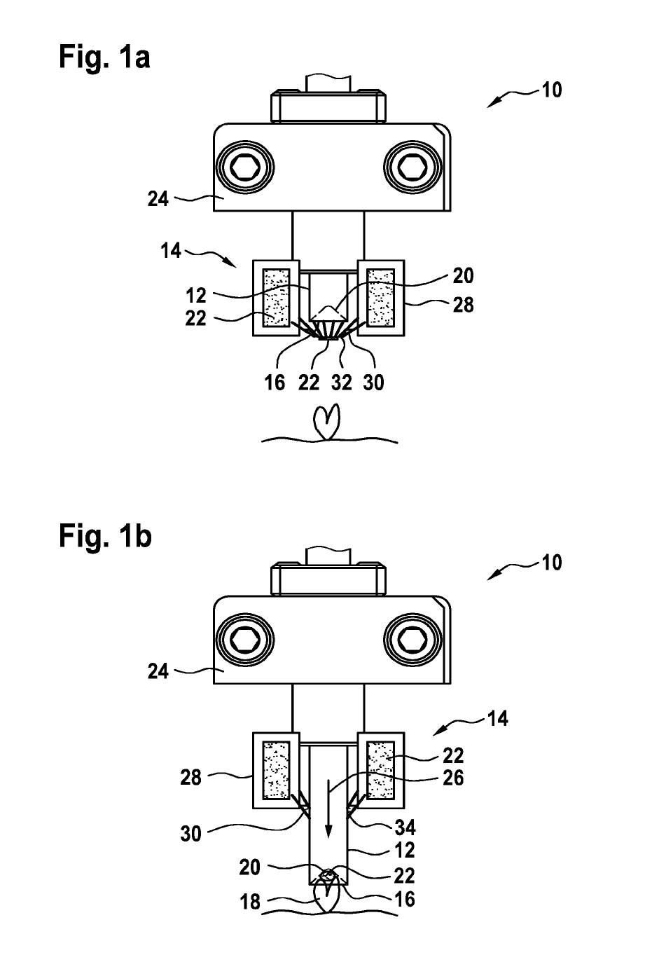

In FIGS. 1a-b, a weed damaging device or device for damaging weeds according to the present invention is provided overall with reference numeral 10.

Device 10 has a plunger 12 and an active-substance dispensing unit 14.

Plunger 12 is of an elongate configuration. Plunger 12 is of a circular cylindrical configuration. Plunger 12 has a plunger end 16. Plunger end 16 is used to apply pressure to a weed 18 in order to damage it mechanically. Plunger 12 has a depression 20 at its plunger end 16. Depression 20 is of a conical or frustoconical configuration. Depression 20 is used to receive an active substance 22. Active substance 22 is used to additionally chemically damage the mechanically pre-damaged weed 18. By virtue of the configuration of depression 20, plunger end 12 is of a sharp-edged configuration in the circumferential direction. Accordingly, plunger end 16 is configured as an annular cutting edge 16 in order to mechanically damage the weed 18 more effectively.

Plunger 12 is mounted on a bearing element 24 to allow translational movement. In this case, plunger 12 is mounted in such a way that it is able to be extended in arrow direction 26 from a retracted position shown in FIG. 1a to a pressure application position shown in FIG. 1b.

Active-substance dispensing unit 14 is of an annular configuration. Active-substance dispensing unit 14 is arranged around the plunger 12 in the circumferential direction. Active-substance dispensing unit 14 has an active-substance chamber 28 which contains the active substance 22.

Active-substance dispensing unit 14 is used to dispense the active substance 22 onto the plunger end 16 of plunger 12. During this process, the active substance 22 may be conveyed, guided, squirted, or sprayed onto the plunger end 16, or transferred to said plunger end via brushing contact or dispensed to it in any way known to a person skilled in the art.

In the weed damaging device 10 shown in FIGS. 1a-b, the active substance 22 is dispensed onto the plunger end 16 by brushing contact. For this purpose, active-substance dispensing unit 14 has a multiplicity of feed lines 30. Feed lines 30 are connected fluidically to active-substance chamber 28. Feed lines 30 are arranged outside plunger 12. Feed lines 30 each have an opening 32. Openings 32 of the feed lines 30 are arranged in a ring shape around the plunger end 16 of the plunger 12.

As can be seen from FIG. 1a, plunger end 16 is arranged ahead of the openings 32 in the retracted position or in the retracted state, in direction 26 of the extending movement. In this case, openings 32 of feed lines 30 are arranged in such a way in the region of the plunger end 16 of plunger 12 that, during an extending movement of the plunger 12 from the retracted position into the pressure application position shown in FIG. 1b, brushing contact arises between the plunger end 16 and the openings 32 of the feed lines 30. This enables the plunger end 16 or the depression 20 to take along or pick up a predefined or small quantity of active substance 22 during the extending movement of the plunger 12. That is to say, in other words, that feed lines 30 of active-substance dispensing unit 14 form an activation unit 34 which brings about the dispensing of the active substance 22 onto the plunger end 16 of plunger 12. In this case, the dispensing of active substance 22 is brought about upon brushing contact between the plunger end 16 and the feed lines 30 and thus in accordance with the position of plunger 12 relative to active-substance dispensing unit 14. Accordingly, activation unit 34 is configured as a “wiper” or “wiper ring”, which is wetted with the active substance 22. By virtue of the fluidic connection of the feed lines 30 to the active-substance chamber 28, additional active substance 22 for the subsequent punching operation is fed in after dispensing.

As can furthermore be seen from FIG. 1b, pressure is applied to the weed 18 by the plunger end 16 after the dispensing of active substance 22 onto plunger end 16 or depression 20 of plunger 12, as a result of which weed 18 is mechanically damaged. Since the plunger end 12 also has active substance 22, active substance 22 is furthermore dispensed from the plunger end 12 onto weed 18 by contact transfer during or after the mechanical damaging of weed 18. Accordingly, the mechanically pre-damaged weed 18 is additionally chemically damaged.

Consequently, by virtue of the fact that mechanical damaging of weed 18 is carried out simultaneously with or directly before the transfer of active substance 22 to the weed 18, the chemical damaging or killing of the weed 18 can be achieved with a considerably lower quantity of active substance 22.

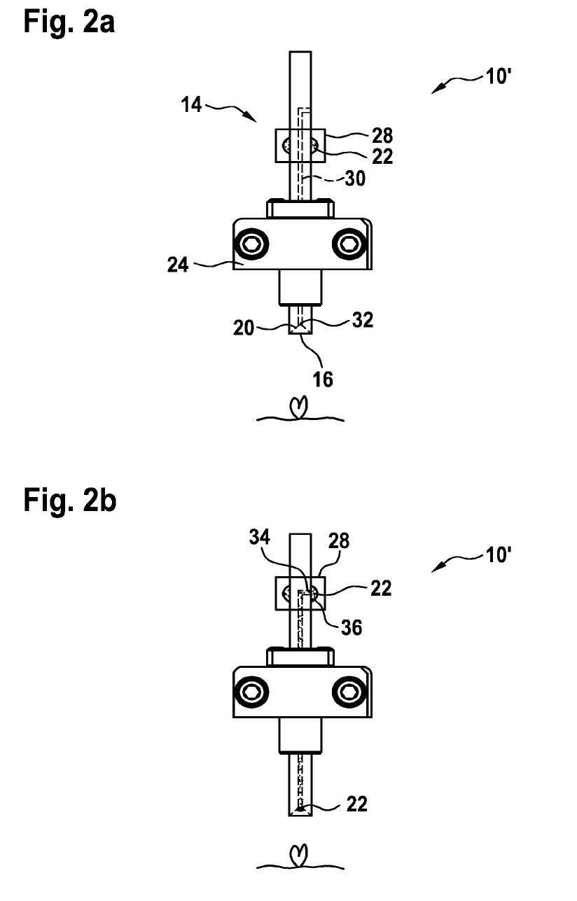

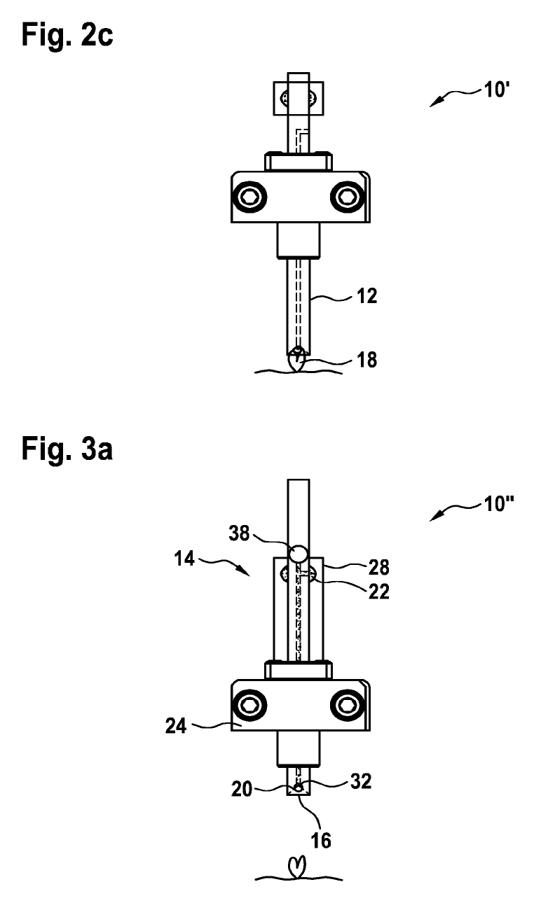

Another specific embodiment of a device 10′ according to the present invention is shown in FIGS. 2a-c. In comparison with device 10 from FIGS. 1a-b, the active-substance dispensing unit 14 has just one feed line 30, which is arranged within the plunger 12. In this case, the opening 32 of the feed line 30 is connected fluidically to plunger end 16 or depression 20. Furthermore, feed line 30 is connected or may be connected fluidically to active-substance chamber 28. In this case, the active-substance chamber 28 has an annular channel 36. Accordingly, the plunger end 16 may be connected fluidically by way of feed line 30 to annular channel 36 and hence to active-substance chamber 28. In this case, the fluidic connection is configured to be interrupted as a function of a travel of plunger 12.

As can be seen from FIG. 2a, feed line 30 is separated from active-substance chamber 28 in the retracted position of plunger 12. Accordingly, feed line 30 and hence also the plunger end 16 or the depression 20 do not have any active substance 22. In this case, plunger 12 closes the annular channel 36 of active-substance chamber 28 somewhat like a valve spool.

At a predefined travel of the plunger 12, which is illustrated in FIG. 2b, there is a fluidic connection between feed line 30 and hence plunger end 16 and active-substance chamber 28. Active substance 22, which may be under pressure, is accordingly able to pass out of active-substance chamber 28, through feed line 30, to plunger end 16 or depression 20. More specifically, plunger 12 brushes past annular channel 36 during the extending movement. One or more bore holes that extend radially outward and which form part of feed line 30 and form activation unit 34 in interaction with annular channel 36 are arranged in plunger 12 itself. Accordingly, a small quantity of active substance is forced into plunger 12 during the extending movement as plunger 12 brushes past annular channel 36 and is conveyed downward to plunger end 16 or to depression 20 by way of feed line 30. Instead of annular channel 36, one or more bore holes is/are also conceivable. If plunger 12 is mounted in bearing element 24 in a manner secured against rotation, the bore hole or bore holes of plunger 12 may then come into overlap with the bore hole or bore holes of active-substance chamber 28 and thereby establish a fluidic connection. If there is no safeguard against rotation, in the case of a simple circular plunger 12 for example, the one or more bore holes of the plunger 12 may overlap with the annular channel 36 and thereby establish a fluidic connection. The position of the bore holes or bore hole/annular channel combination with respect to one another determines the time of active substance transfer, while the size of the bore holes/of the annular channel or the pressure to which active substance 22 is subject and the speed at which the plunger is extended determine the active-substance or application rate. The active substance or application rate may likewise be varied by varying the bore hole cross section and by rotating plunger 12.

As shown in FIG. 2c, the fluidic connection of feed line 30 to active-substance chamber 28 is interrupted again after a continuation of the extending movement of plunger 12. When the pressure application position is reached, weed 18 is mechanically damaged by plunger end 16 of plunger 12. During this process, contact transfer of active substance 22 situated on plunger end 16 or in depression 20 to pre-damaged weed 18 takes place simultaneously or directly after the mechanical damage, thereby ensuring that the weed is additionally chemically damaged.

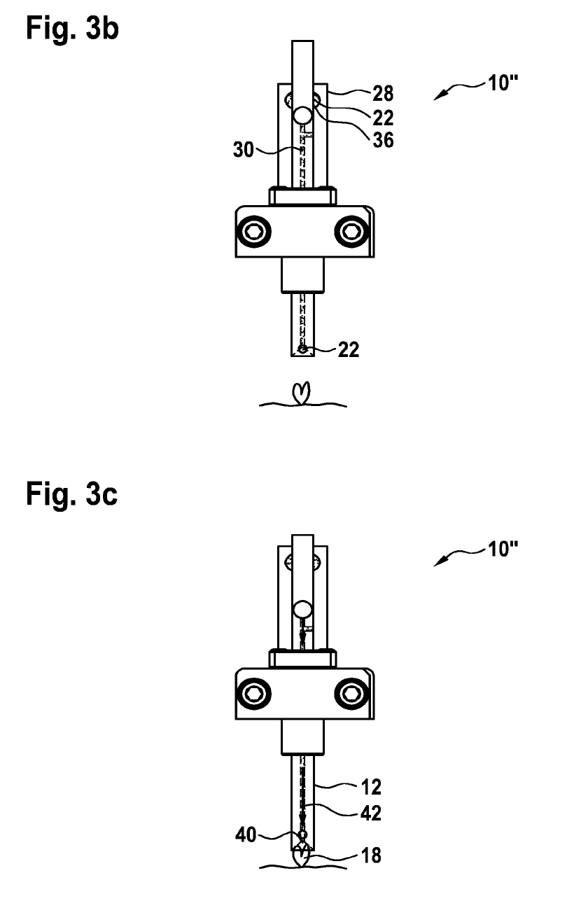

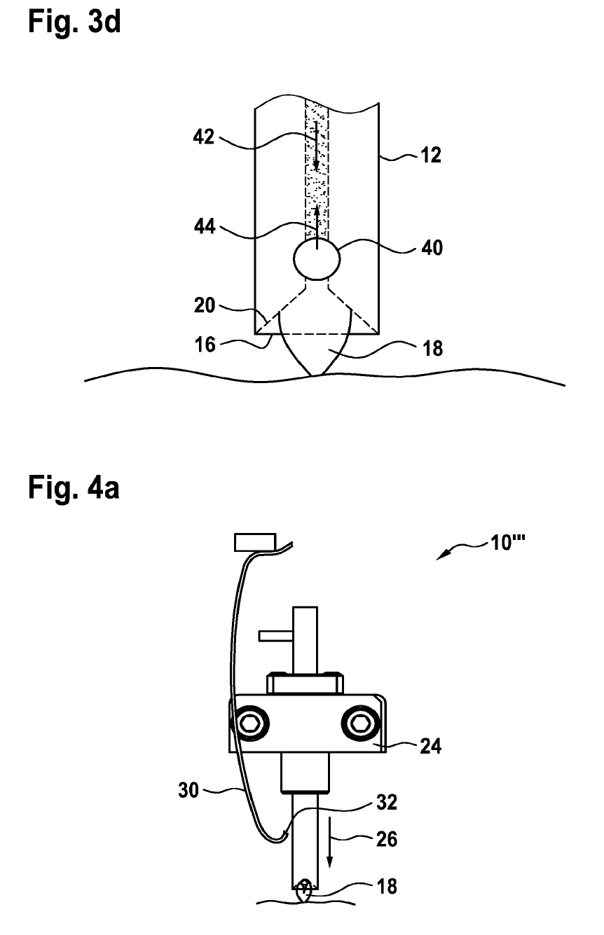

Another specific embodiment of a device 10″ according to the invention is shown in FIGS. 3a-d. In comparison with the device 10′ from FIGS. 2a-c, active-substance dispensing unit 14 additionally has a pressure reservoir 38. Pressure reservoir 38 is here developed as a rubber bladder. However, it is also conceivable for the pressure reservoir 38 to be configured as a gas bladder or as a resilient membrane. Pressure reservoir 38 is arranged within plunger 12. Pressure reservoir 38 is furthermore connected to feed line 30. Pressure reservoir 38 is configured to apply pressure to an active substance 22 situated in feed line 30. Feed line 30 is likewise of a different configuration, as described in greater detail below.

Another difference from device 10′ is that the activation unit 34 has a valve 40. Valve 40 is here configured as a return valve 40. Valve 40 is situated at opening 32 of feed line 30. Accordingly, valve 40 is arranged between feed line 30 and plunger end 16 or depression 20. Valve 40 is configured to open at a predefined pressure force counter to a flow direction 42 of the active substance 22 in order to bring about dispensing of the active substance 22 onto the plunger end 16.

As in the specific embodiment shown in FIGS. 2a-c, the plunger end 32 in device 10″ is connected or may be connected fluidically to annular channel 36 and thus to active-substance chamber 28 by way of feed line 30. In this case, the fluidic connection is likewise configured to be interrupted as a function of a travel of plunger 12.

As can be seen from FIG. 3a, feed line 30 is connected fluidically to active-substance chamber 28 or annular channel 36 in the retracted position of plunger 12. Accordingly, feed line 30 contains active substance 22. Since no pressure force is acting on valve 40, valve 40 is closed so that active substance 22 cannot escape from the feed line 30 to the plunger end 16 or depression 20.

Starting at a predefined travel of plunger 12, which is illustrated in FIG. 3b, feed line 30 is fluidically separated from active-substance chamber 28. In this case, plunger 12 closes the annular channel 36 of active-substance chamber 28 somewhat like a valve spool. Accordingly, there is a defined volume of active substance 22 in feed line 30, which is pressurized on account of pressure reservoir 38.

As shown in FIG. 3c, weed 18 is mechanically damaged by plunger end 16 of plunger 12 when the pressure application position is reached. In this process, weed 18, to which pressure is applied or which is compressed—as illustrated in greater detail in FIG. 3d—exerts a pressure on the valve 40 in the direction of arrow 44 simultaneously with or directly after the mechanical damage. During this process, the valve ball of valve 40 is pushed upward by the plant mass, with the result that the closed valve 40 opens due to the pressure force. Accordingly, activation unit 34 of active-substance dispensing unit 14 is configured to bring about dispensing of active substance 22 onto plunger end 16 of the plunger 12 as a function of a pressure force acting on plunger end 16 or valve 40. The active substance 22 situated in the feed line 30 is thereby dispensed to depression 20 and hence, by contact transfer, to pre-damaged weed 18, thereby ensuring that the weed is additionally chemically damaged.

The active substance quantity to be applied may be adjusted by varying the pressure in feed line 30 or the pressure acting on the active substance 22.

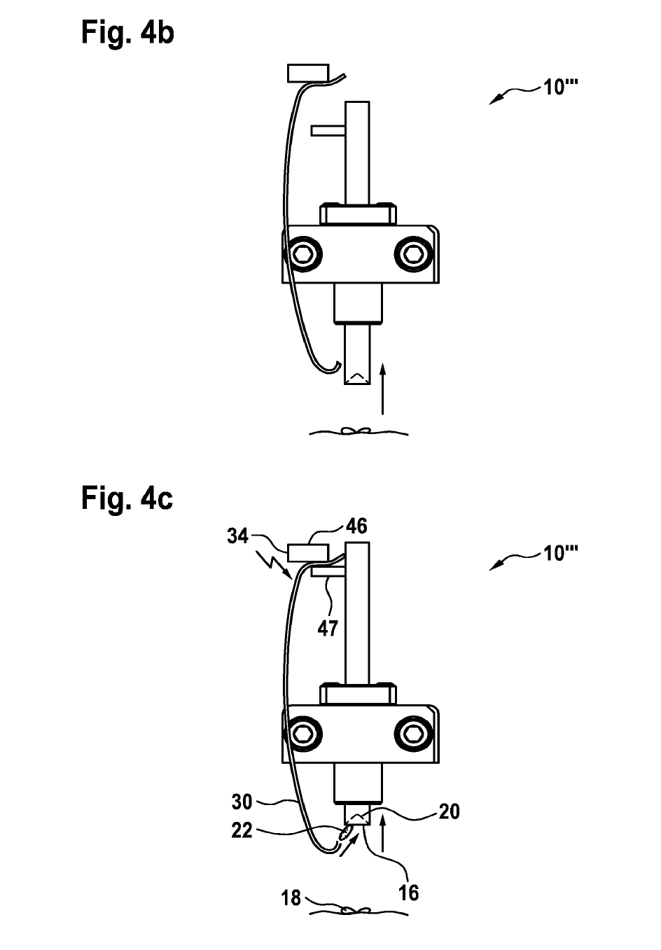

Another specific embodiment of a device 10′″ according to the present invention is shown in FIGS. 4a-c. In contrast to the embodiments described above, the active-substance dispensing unit 14 is here configured to spray or squirt active substance 22 onto plunger end 16 or depression 20 from outside plunger 12. For this purpose, the active-substance dispensing unit 14 has a pumping unit (not shown), and the activation unit 34 has a stop 46.

Moreover, feed line 30 of active-substance dispensing unit 14 is situated outside plunger 12, the opening 32 of feed line 30 being situated in the region of plunger end 16 in a retracted position of plunger 12, as shown in FIG. 4c. Feed line 30 is connected fluidically to pumping unit. Feed line 30 is furthermore connected to stop 46 or coupled mechanically thereto.

FIGS. 4a-b show how plunger 12 returns to the retracted position from the pressure application position after the application of pressure to weed 18 and the dispensing of the active substance 22 to pre-damaged weed 18.

As shown in FIG. 4c, the return or upward movement of plunger 12 is used to activate the pumping unit and thereby to initiate a pumping process which sprays or squirts a small or predefined quantity of active substance 22 from active-substance chamber 28 into depression 20.

Here, activation unit 34 or stop 46 is configured in such a way that plunger 12 or a lever 47 of plunger 12 strikes stop 46 upon reaching the retracted position and brings about a pumping process in order to dispense a defined quantity of active substance 22 onto plunger end 16. The pumping process may be accomplished by squeezing feed line 30, the pumping unit in this case having a return valve. The pumping process may also be accomplished by a diaphragm or piston pump, which is actuated by way of lever 47 and is part of the pumping unit. Moreover, the exhaust air of the punching stroke or of the return stroke may be used to transfer active substance 22 directly, i.e. by pressure, or indirectly, i.e. by way of the diaphragm or piston pump.

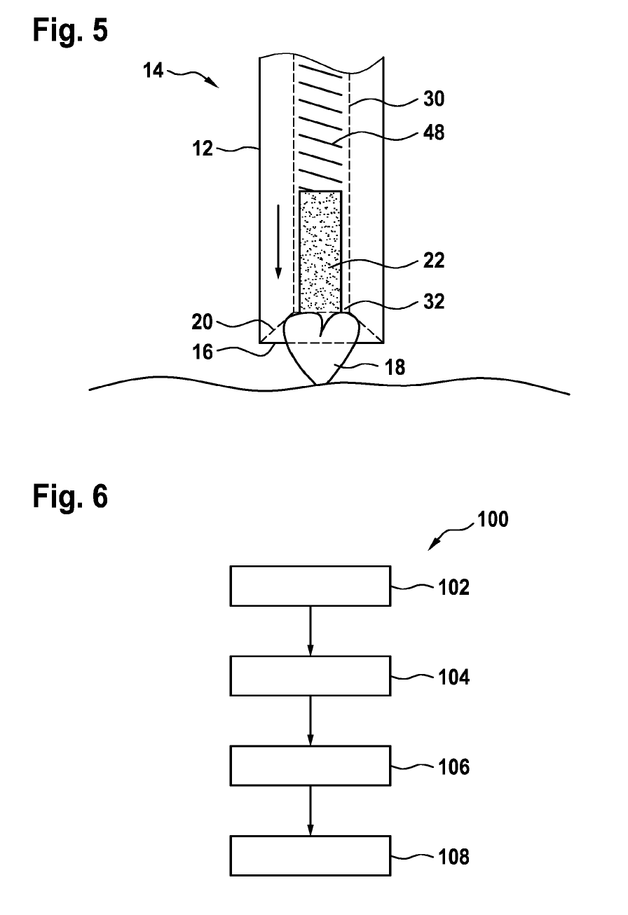

Another specific embodiment of a plunger 12 is shown in FIG. 5. In this case, active substance 22 is configured as a solid, i.e. in the form of a solid. Active substance 22 has a pin shape. Active substance 22 or active substance pin 22 is situated in feed line 30. Active substance pin 22 is situated at the opening 32 of feed line 30, adjoining plunger end 16 or depression 20. Active substance pin 22 thus partially forms the base of the depression 20.

Here, feed line 30 is configured as a pocket hole. Active-substance dispensing unit 14 comprises a compression spring 48. Compression spring 48 pushes active substance pin 22 in the direction of opening 32. In this case, opening 32 is configured in such a way that active substance pin 22 may be contacted at the plunger end while nevertheless remaining in the feed line 30 despite the spring loading.

During operation, the plunger-end surface of active substance pin 22 is wetted by the escaping plant fluids of weed 18 during or after each pressure application or plunger movement. During the waiting time until the next pressure application or plunger movement, very small quantities of active substance 22 are thereby dissolved, and these are transferred to the punched or damaged weed 18 when pressure is subsequently applied. When the device is not in use, active substance pin 22 automatically dries out, thereby stopping the dissolution of active substance on active substance pin 22.

In all embodiments shown in FIGS. 1 to 5, it is also conceivable, alternatively or in addition, for activation unit 34 to have a pressure sensor (not shown), which is situated on plunger end 16 of plunger 12. The pressure sensor may be connected to the above-mentioned diaphragm or piston pump and/or to valve 40 so that the dispensing of active substance 22 onto plunger end 16 or depression 20 is effected by a signal of the pressure sensor as a function of a predefined pressure acting on plunger end 16 or the pressure sensor.

FIG. 6 shows a flow chart of an exemplary embodiment as method 100 for damaging weeds 18. Method 100 comprises a step 102 of supplying a movably arranged plunger 12 having a plunger end 16. In particular, step 102 comprises supplying a device 10, 10′, 10″, 10′″ in accordance with FIGS. 1 through 5. Method 100 furthermore comprises a step 104 of dispensing an active substance 22 onto plunger end 16 of plunger 12 by way of an active-substance dispensing unit 14. Method 100 furthermore comprises a step 106 of applying pressure to weed 18 via plunger end 16 of plunger 12 in order to damage weed 18 mechanically. Finally, method 100 comprises a step 108 of dispensing active substance 22 from plunger end 16 of plunger 12 onto weed 18 by contact transfer in order additionally to damage chemically the mechanically pre-damaged weed 18.

If an exemplary embodiment includes an “and/or” linkage between a first feature and a second feature, this is to be understood to mean that the exemplary embodiment according to one specific embodiment has both the first feature and the second feature, and according to another specific embodiment, either has only the first feature or only the second feature.

1-15. (canceled)

16. A device for damaging weeds, comprising:
a movably arranged plunger having a plunger end to apply pressure to a weed to damage mechanically the weed; and
an active-substance dispensing unit to dispense an active substance onto the plunger end of the plunger to damage chemically the mechanically pre-damaged weed.

17. The device of claim 16, wherein the active-substance dispensing unit is configured to at least one of convey, guide, spray, and/or squirt the active substance onto the plunger end of the plunger and/or to transfer it to the plunger end by a brushing contact.

18. The device of claim 16, wherein the active-substance dispensing unit has at least one feed line having an opening, and wherein the opening is connected fluidically to the plunger end and/or is arranged in the region of the plunger end in a retracted position of the plunger.

19. The device of claim 18, wherein the feed line is connected and/or is connected fluidically to an active-substance chamber.

20. The device of claim 18, wherein the feed line is situated at least partially within the plunger and the opening of the feed line is connected fluidically to the plunger end of the plunger.

21. The device of claim 18, wherein the feed line is situated at least partially outside the plunger and the opening of the feed line is situated in the region of the plunger end of the plunger.

22. The device of claim 21, wherein the opening of the feed line is situated in the region of the plunger end of the plunger so that, when the plunger moves from the retracted position into a pressure application position, brushing contact occurs between the plunger end and the opening of the feed line.

23. The device of claim 22, further comprising:
a multiplicity of feed lines having openings, which are arranged around the plunger end of the plunger.

24. The device of claim 16, wherein the active-substance dispensing unit has an activation unit to dispense the active substance onto the plunger end of the plunger as a function of a travel distance or a position of the plunger and/or a pressure force acting on the plunger end of the plunger.

25. The device of claim 16, wherein the plunger has a depression at the plunger end to receive the active substance.

26. The device of claim 25, wherein the depression includes a conical or a frustoconical depression.

27. The device of claim 16, wherein the plunger has a sharp-edge at the plunger end.

28. The device of claim 16, wherein the plunger is mounted so that it is translatorily moveable.

29. A system for damaging weeds, comprising:
a device for damaging weeds, including:
a movably arranged plunger having a plunger end to apply pressure to a weed to damage mechanically the weed; and
an active-substance dispensing unit to dispense an active substance onto the plunger end of the plunger to damage chemically the mechanically pre-damaged weed; and
one of a vehicle, an autonomous vehicle, or a handheld device.

30. A method for damaging weeds, the method comprising:
providing a device, including: a movably arranged plunger having a plunger end to apply pressure to a weed to damage mechanically the weed; and an active-substance dispensing unit to dispense an active substance onto the plunger end of the plunger to damage chemically the mechanically pre-damaged weed;
dispensing an active substance onto the plunger end of the plunger using the active-substance dispensing unit;
applying pressure to the weed by the plunger end of the plunger to damage the weed mechanically; and
dispensing the active substance from the plunger end of the plunger onto the weed by contact transfer to damage chemically the mechanically pre-damaged weed.

31. The device of claim 22, further comprising:
a multiplicity of feed lines having openings, which are arranged in a ring shape around the plunger end of the plunger.

32. The device of claim 16, wherein the plunger has a sharp-edge at the plunger end, and wherein the sharp edge includes an annular cutting edge.
